(19) United States
(12) Patent Application Publication
(10) Pub. No.: US 2019/0186409 A1
(43) Pub. Date: Jun. 20, 2019

(54) CYLINDER HEAD FOR ONE INTERNAL COMBUSTION ENGINE

(71) Applicant: GE Jenbacher GmbH & Co OG, Jenbach (AT)

(72) Inventors: Peter Holzhammer, Jenbach (AT); Christoph Hollaus, Jenbach (AT)

(21) Appl. No.: 16/223,153

(22) Filed: Dec. 18, 2018

(30) Foreign Application Priority Data
Dec. 19, 2017 (AT) A51047/2017

(51) Int. Cl. F02F 1/24; F02F 1/42; F02F 11/00

(52) U.S. Cl. CPC F02F 1/242; F02F 11/002; F02F 1/4214

(57) ABSTRACT

A cylinder head for an internal combustion engine is provided, whereby the cylinder head has a cylinder head gasket region for closing a combustion chamber with a diameter. The cylinder head includes the following:
a. two intake holes for receiving one intake valve each;
b. two outlet holes for receiving one outlet valve each; and
c. a spark plug sleeve hole for receiving a spark plug sleeve.

The at least one intake hole of the two intake holes has a diameter between 34.0% and 36.6% of the diameter of the combustion chamber, preferably a diameter between 34.5% and 35.9% of the diameter of the combustion chamber, and particularly preferably a diameter between 34.8% and 35.5% of the diameter of the combustion chamber. The at least one outlet hole has a diameter that, in relation to the diameter of the combustion chamber, is at least 1% smaller than the diameter of the intake holes.

### TECHNOLOGY FIELD

This disclosure relates to a cylinder head for an internal combustion engine, whereby the cylinder head has a cylinder head gasket region for closing a combustion chamber with an inner diameter, and further comprising two intake holes for receiving one intake valve each, two exhaust holes for receiving one exhaust valve each, and a spark plug sleeve hole for housing a spark plug sleeve, as well as an internal combustion engine having at least one cylinder head.

### BACKGROUND OF THE DISCLOSURE

Cylinder heads with a cylinder head gasket region of the same internal diameter are used to close combustion chambers at the top or to form the upper combustion chamber section.

The cylinder heads known in the prior art have two intake holes with a first maximum diameter, whereby the two outlet holes are usually designed to be not larger than a second maximum diameter, such that in a central region of the cylinder head a spark plug sleeve with a given diameter in a designated hole can still be used.

It is important in selecting the size of the intake holes and the outlet holes that the cylinder head permits a sufficiently good “breathing” of the combustion chamber. This breathing is understood to mean the ratio of the size of the intake valves to the size of the exhaust valves. Breathing is defined by the fact that the combustion chamber must be able to “breathe” a sufficiently large volume over time through the intake valves. Through this breathing in, the supply of an air-fuel mixture through the intake valves is defined in the combustion chamber, whereby the piston that is arranged in the combustion chamber, during a downward movement (that increases the current volume in the combustion chamber), the fuel-gas mixture is introduced into the combustion chamber. After combustion, the combustion residues or the outlet gases must be “breathed out” again from the combustion chamber through the outlet valves. This breathing out in turn means that, through an upward movement of the piston (that leads to a decrease in the volume in the combustion chamber), the combustion residues are expelled through the outlet valves. A good breathing of the combustion chamber can only exist if the intake holes have a certain ratio to the outlet holes with regard to their diameter, such that a sufficiently large volume of fuel-air mixture can be supplied to the combustion chamber and this can be discharged again after the combustion, whereby sufficient fuel for the combustion is provided and the residues resulting from the combustion can also be removed after the combustion, such that the minimum combustion residues are present in the following combustion or in the following intake cycle.

However, there is a desire to select the intake holes to be as large as possible in order to be able to supply the combustion chamber with a larger amount of energy through the fuel-air mixture, which in turn, however, results in an increase in the outlet holes, since otherwise a sufficient “breathing” of the combustion chamber can no longer be guaranteed.

It has been shown that, in cylinder heads with a cylinder head gasket region, there is an upper limit for the diameters of the intake valves and outlet valves, since with further enlargement of the holes sufficient strength of the cylinder head can no longer be guaranteed.

### SUMMARY OF THE DISCLOSURE

The object of the disclosure is to provide a cylinder head that permits a better breathing of the combustion chamber and allows it to supply a larger volume over time and/or discharge a larger volume over time.

This object is achieved by a cylinder head for an internal combustion engine with the features of claim 1.

According to the disclosure, it is provided that at least one intake hole of the two intake holes has a diameter between 34.0% and 36.6% of the diameter of the combustion chamber, between 34.5% and 35.9% of the diameter of the combustion chamber, and particularly has a diameter between 34.8% and 35.5% of the diameter of the combustion chamber. In order to obtain the necessary strength, the at least one outlet hole is designed such that it has a diameter that, in relation to the diameter of the combustion chamber, is at least 1% smaller than the diameter of the intake holes relative to the diameter of the combustion chamber. In this way, it is ensured that the remaining wall enclosing the spark plug sleeve hole retains sufficient stability.

In an embodiment, the cylinder head has a cylinder head gasket region for closing a combustion chamber with a diameter of 145 mm. In this example, it is provided that at least one intake hole of the two intake holes has a diameter of 49.5 mm to 53 mm, a diameter of 50 mm to 52 mm, and particularly a diameter of 50.5 mm to 51.5 mm.

In this embodiment, the spark plug sleeve may have a given diameter of up to 28 mm.

It can be provided that the two intake holes each have a diameter of 49.5 mm to 53 mm, a diameter of 50 mm to 52 mm, and particularly a diameter of 50.5 mm to 51.5 mm.

It is provided that at least one of the two outlet holes has a diameter smaller than the diameter of the two intake holes, a diameter of 48 mm to 50 mm. In an exemplary embodiment, it can be provided that the two outlet holes each have a diameter smaller than the diameter of the two intake holes, a diameter of 48 mm to 50 mm.

In an embodiment, it can be provided that the spark plug sleeve hole has a diameter of less than 28 mm and has a diameter of greater than 23.5 mm. In an embodiment, the spark plug sleeve has a diameter of 24 mm. A spark plug sleeve hole with a diameter of less than 28 mm can strengthen the stability of the cylinder head, and the intake and outlet holes can thus be enlarged.

In addition, it can be provided that the spark plug sleeve hole is arranged substantially in the center of the cylinder head. “Substantially in the center” can here be understood to mean that the spark plug sleeve hole overlaps the center axis of the cylinder head.

It can also be provided that the cylinder head has at least one cavity for receiving and/or conducting a cooling medium. Thus, for example, a cavity can be provided in the cylinder head that has a cooling intake and a cooling outlet. During the operation of the cylinder head, a cooling medium can then be passed through the cylinder head or its cavity in order to discharge the heat generated by the combustion and thus cool the surrounding components of the combustion chamber.

The spark plug sleeve hole for securing the position of the spark plug sleeve has a thread at least in one section. By means of such a thread, the spark plug sleeve can be fixed by screwing the spark plug sleeve with its thread into the thread of the cylinder head that is arranged in the spark plug sleeve hole.

In addition, or alternatively, it can be provided that the spark plug sleeve hole for securing the position of the spark plug sleeve has a cylindrical fit at least in one section. By means of such a cylindrical fit, the spark plug sleeve can be guided through a clearance fit in the spark plug sleeve hole or fixed by a press fit in the spark plug sleeve hole.

In a further exemplary embodiment, it can be provided that a center axis of the spark plug sleeve hole is arranged parallel to a center axis of the cylinder head and is arranged at a distance apart, parallel to the center axis of the cylinder head. The spark plug sleeve hole can thus be arranged substantially in the center of the cylinder head, which in turn means that, in a final installation situation, the spark plug sleeve is arranged substantially in the center of the combustion chamber. The spark plug sleeve hole can be parallel to and at a distance apart, parallel to the center axis of the cylinder head. The spark plug sleeve hole or the spark plug sleeve can thus be arranged slightly eccentrically in an installed state of the combustion chamber.

Protection is also sought for an internal combustion engine having at least one cylinder head according to the disclosure.

### BRIEF DESCRIPTION OF THE DRAWINGS

Various embodiments of the disclosure are shown in the figures. The figures show the following:

FIG. 1 a spark plug sleeve in the installed state;

FIG. 2 a first embodiment of a cylinder head according to the disclosure in a simplified cross-section;

FIG. 3 a second embodiment of a cylinder head according to the disclosure in a simplified cross-section; and

FIG. 4 a third embodiment of a cylinder head according to the disclosure in a simplified cross-section.

### DETAILED DESCRIPTION

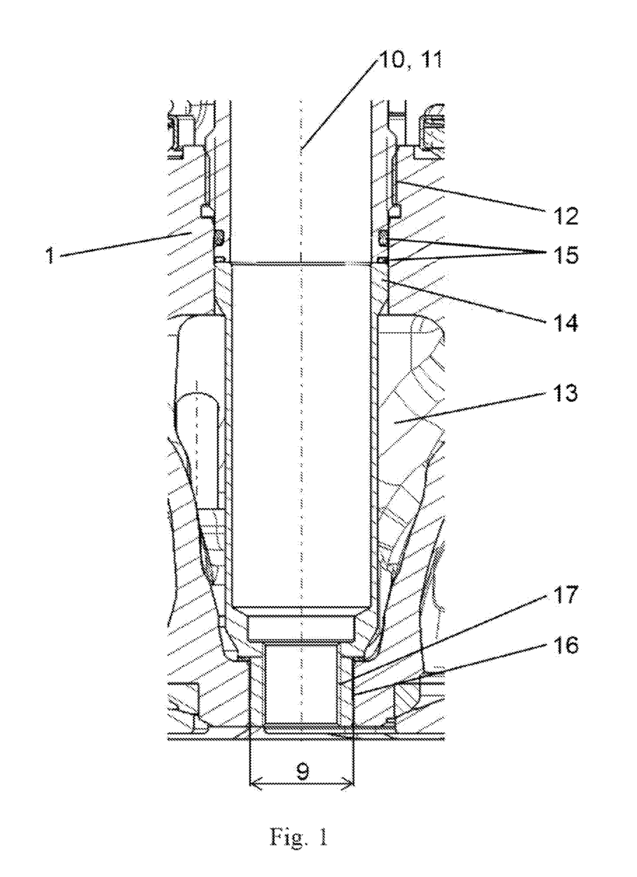

FIG. 1 shows a spark plug sleeve 14 in an installed state in a cylinder head 1. The spark plug sleeve 14 is fixed in the cylinder head 1 by a press fit in the spark plug sleeve hole 6. This spark plug sleeve hole 6 has a diameter 9. In the upper section of the spark plug sleeve hole 6, a thread 12 is provided that serves to secure the spark plug sleeve 14 in its position in the cylinder head 1. The connection between the cylinder head 1 and the spark plug sleeve 14 is established by a screw connection that is fixed in the thread 12 of the cylinder head 1.

In this embodiment, the center axis of the spark plug sleeve hole 6 is not only parallel to the center axis 11 of the cylinder head 1, but also has no spacing to it. (The center axis 11 of the spark plug sleeve hole 6 coincides with the center axis 10 of the cylinder head 1.)

In the exemplary embodiment of FIG. 1, a cavity 13 is provided for receiving a cooling medium or for conducting a cooling medium. In the operating state of the cylinder head 1, a cooling medium can flow around the spark plug sleeve 14 and thus cool it. A leakage of the cooling medium accommodated by the cavity 13 is prevented toward the bottom by the press fit 16 between the cylinder head 1 and the spark plug sleeve 14. Toward the top, this seal is created by the two gaskets 15 shown (designed as O-rings).

To accommodate the spark plug, the receptacle 17 is provided in the spark plug sleeve 14 (a thread).

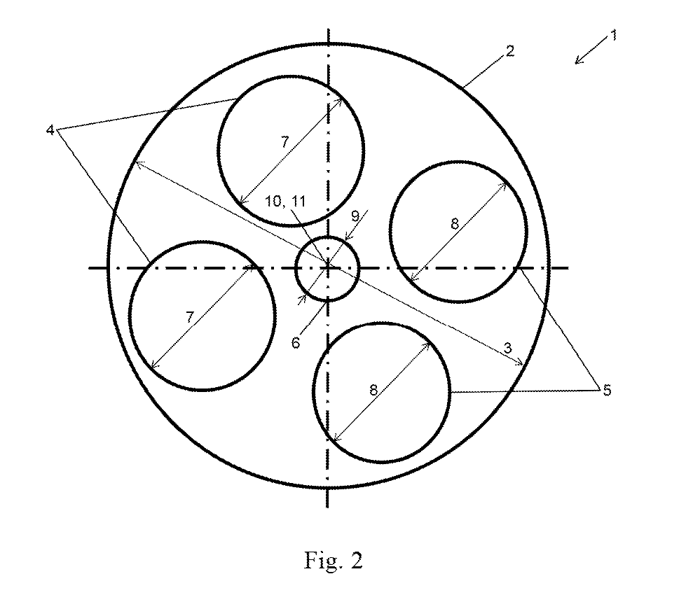

FIG. 2 shows a first embodiment of a cylinder head 1 according to the disclosure in a simplified cross-section. Here the cylinder head 1 has a cylinder head gasket region 2 with a diameter 3 of 145 mm. This cylinder head gasket region 2 forms, with its diameter 3, the delimitation of the combustion chamber, as a result of which the intake valves, outlet valves and the spark plug must be arranged within this cylinder head gasket region 2.

Two intake holes 4 are provided that have a diameter 7. This diameter 7 of the intake holes 4 is designed in this embodiment as 51 mm equally for both intake holes 4 shown. Two outlet holes 5 also with an identical diameter 8 of 45 mm are also provided.

The spark plug sleeve hole 6 is arranged with its center axis 11 along the center axis 10 of the cylinder head 1 and with a diameter 9 of 24 mm. It can be seen from this exemplary embodiment how, despite the enlarged diameter 7 of the intake holes 4, despite the enlarged diameters 8 of the outlet holes 5 and despite the spark plug sleeve hole 6, sufficient material remains between the holes such that the cylinder head 1 has sufficient stability for operation.

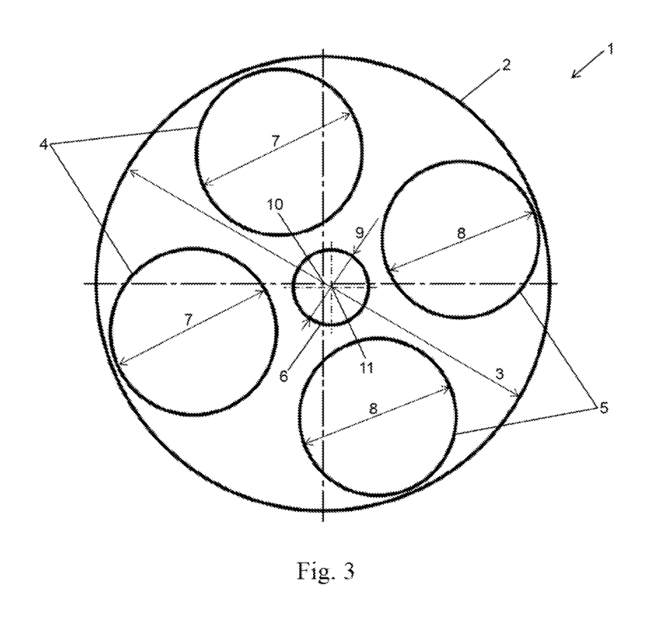

FIG. 3 shows a second embodiment of a cylinder head 1 according to the disclosure in a simplified cross-section. In this embodiment, in contrast to FIG. 2, the center axis 11 of the spark plug sleeve hole 6 is arranged at a distance from the center axis 10 of the cylinder head 1. The diameter 9 of the spark plug sleeve hole 6 is also designed in this embodiment with a diameter of 24 mm. Due to this distance of the center axis 11 of the spark plug sleeve hole 6 from the center axis 10 of the cylinder head 1, the diameters 7 of the intake holes 4 can now be further increased (as shown here, to a size of 53 mm). In addition, the diameter 8 of the outlet holes 5 can be further increased (implemented here with a dimension of 50 mm). Nevertheless, in this embodiment, sufficient material between the holes (bars) is still provided to provide the cylinder head 1 with sufficient stability in operation.

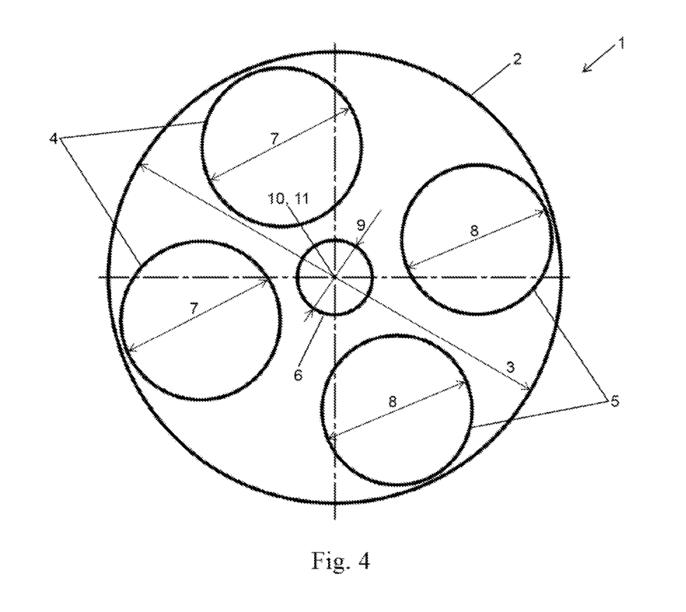

FIG. 4 shows a third embodiment of a cylinder head 1 according to the disclosure in a simplified cross-section. Similarly to FIG. 2, the center axis 10 of the cylinder head 1 once again coincides with the center axis 11 of the spark plug sleeve hole 6. In contrast to FIG. 2, however, the diameter 9 of the spark plug sleeve hole 6 is larger. (More precisely, the diameter 9 of the spark plug sleeve hole 6 has a size of 26 mm.) The diameters 8 of the outlet holes 5 are here designed with a size of 49 mm, and the diameters 7 of the intake holes 4 are designed with a dimension of 49.5 mm. The remaining features correspond to those of FIG. 2.

What we claim is:

1. A cylinder head for an internal combustion engine, the cylinder head comprising:
a cylinder head gasket region for closing a combustion chamber having a diameter;
two intake holes for receiving one intake valve each;
two outlet holes for receiving one outlet valve each; and
spark plug sleeve hole for receiving a spark plug sleeve;
wherein at least one intake hole of the two intake holes has a diameter between 34.0% and 36.6% of the diameter of the combustion chamber, and the at least one outlet hole has a diameter that, in relation to the diameter of the combustion chamber, is at least 1% smaller than the diameter of the intake holes.

2. The cylinder head according to claim 1, wherein the diameter is 145 mm, and at least one of the two intake holes has a diameter of 49.5 mm to 53 mm.

3. The cylinder head according to claim 1, wherein at least one outlet hole of the two outlet holes has a diameter smaller than the diameter of the two intake holes, and a diameter 48 mm to 50 mm.

4. The cylinder head according to claim 1, wherein the two outlet holes each have a diameter smaller than the diameter of the two intake holes, and a diameter of 48 mm to 50 mm.

5. The cylinder head according to claim 1, wherein the spark plug sleeve hole has a diameter smaller than 28 mm, and has a diameter greater than 23.5 mm.

6. The cylinder head according to claim 1, wherein the spark plug sleeve hole is arranged substantially in the center of the cylinder head.

7. The cylinder head according to claim 1, wherein the cylinder head has at least one cavity for receiving and/or conducting a cooling medium.

8. The cylinder head according to claim 1, wherein the spark plug sleeve hole for securing the position of the spark plug sleeve has a thread at least in one section.

9. The cylinder head according to claim 1, wherein the spark plug sleeve hole for securing the position of the spark plug sleeve has a cylindrical fit at least in one section.

10. The cylinder head according to claim 1, wherein a center axis of the spark plug sleeve hole is arranged at a distance from a center axis of the cylinder head.

11. The cylinder head according to claim 1, wherein a center axis of the spark plug sleeve hole is arranged parallel to a center axis of the cylinder head.

12. An internal combustion engine having at least one cylinder head according to claim 1.
